(19) United States
(12) Patent Application Publication
(10) Pub. No.: US 2026/0028261 A1
(43) Pub. Date: Jan. 29, 2026

(54) SYSTEM AND METHOD FOR TREATMENT AND REUSE OF RENEWABLE ENERGY PRODUCTION WASTEWATER

(71) Applicant: Evoqua Water Technologies LLC, Pittsburgh, PA (US)

(72) Inventors: Hari Bhushan Gupta, Schaumburg, IL (US); Ivan Zhu, Sewickley, PA (US); Robert J. Wenta, Junction City, WI (US); Daniel Bertoldo, Fredericton (CA); Shannon Grant, New Maryland (CA); Justin Wayne Higgs, Fairview, NC (US)

(21) Appl. No.: 19/145,544

(22) PCT Filed: Feb. 3, 2023
(86) PCT No.: PCT/US2023/012310

§ 371 Date: Jul. 3, 2025

Related U.S. Application Data
(60) Provisional application No. 63/436,754, filed on Jan. 3, 2023.

(51) Int. Cl. C02F 9/00; C02F 1/38; C02F 1/44; C02F 1/68; C02F 3/30; C02F 101/34

(52) U.S. Cl. CPC C02F 9/00; C02F 1/38; C02F 1/44; C02F 1/68; C02F 3/30; C02F 2101/345

(57) ABSTRACT

A method of treating wastewater from a renewable fuel production comprises anaerobically digesting the wastewater to produce digestate and sludge, aerobically treating the digestate to produce an effluent and a second sludge, separating the effluent into a first filtrate and a first reject, treating the sludge, second sludge, and first reject in a solids-liquid separation apparatus to produce recovered water, directing the recovered water into the mixing tank, filtering the first filtrate in a nanofiltration unit to produce a second filtrate and a second reject, filtering the second filtrate in a first reverse osmosis unit to produce a third filtrate and a third reject, filtering the third reject in a second reverse osmosis unit to produce a fourth filtrate and a fourth reject, combining the third filtrate and fourth filtrate to form a product water, and combining the second reject and the fourth reject into a combined reject for disposal.

### CROSS-REFERENCE TO RELATED APPLICATIONS

This application is a U.S. National Stage entry of International Patent Application No. PCT/US2023/012310 filed Feb. 3, 2023, which claims priority 35 U.S.C. § 119(e) to U.S. Provisional Patent Application Ser. No. 63/436,754 filed Jan. 3, 2023 and titled “System and Method for the Treatment and Reuse of Renewable Energy Production Wastewater,” each of which are incorporated herein by reference in their entirety for all purposes.

### FIELD OF TECHNOLOGY

Aspects and embodiments disclosed herein are generally related to treatment of wastewater containing organic compounds, and more specifically, to recovery of water during treatment of wastewater containing phenolic compounds, high concentrations of organic compounds, and a high concentration of total dissolved solids.

### SUMMARY

In accordance with one aspect, there is provided a method of treating wastewater from a renewable fuel production facility including high levels of phenolics. The method comprises anaerobically digesting the wastewater to produce a biogas, a digestate, and a waste sludge, aerobically treating the digestate in an aerobic membrane bioreactor to produce an aerobically treated, low-solids effluent and a second waste sludge, dosing the aerobically treated, low-solids effluent with a coagulant and softening agent in a mixing tank to produce a partially treated wastewater, separating the partially treated wastewater in a cross flow membrane filtration unit into a first filtrate and a first reject, treating the waste sludge, second waste sludge, and first reject in a solids-liquid separation apparatus to produce recovered water and waste solids, directing the recovered water into the mixing tank, dosing the first filtrate with an antiscalant to produce a dosed first filtrate, filtering the dosed first filtrate in a nanofiltration unit to produce a second filtrate and a second reject stream, dosing the second filtrate with an antiscalant to produce a dosed second filtrate, filtering the dosed second filtrate in a first reverse osmosis unit to produce a third filtrate and a third reject stream, dosing the third reject stream with an antiscalant to form a dosed third reject stream, filtering the dosed third reject stream in a second reverse osmosis unit to produce a fourth filtrate and a fourth reject, combining the third filtrate and fourth filtrate to form a product water, and combining the second reject stream and the fourth reject stream into a combined reject stream for disposal.

In some embodiments treating the waste sludge, second waste sludge, and first reject to produce the recovered water and waste solids is performed in a centrifuge.

In some embodiments, the method further comprises processing the biogas to produce natural gas.

In some embodiments, the method further comprises using energy generated by the biogas to power at least one operation of the method.

In some embodiments, the method further comprises introducing a portion of the organic material-containing wastewater directly into the aerobic membrane bioreactor without first treating the portion of the organic material-containing wastewater in the anaerobic bioreactor.

In some embodiments, the method further comprises adjusting a pH of the wastewater to about 6 or above prior to anaerobically digesting the wastewater.

In some embodiments, the method further comprises pre-treating the wastewater to remove oil, suspended solids, and ammonia prior to anaerobically digesting the wastewater.

In accordance with another aspect, there is provided a system for treating wastewater from a renewable fuel production facility including high levels of phenolics. The system comprises an anaerobic bioreactor having an inlet fluidly connectable to a source of wastewater, a biogas outlet, a digestate outlet, and a sludge outlet, an aerobic membrane bioreactor having an inlet fluidly connected to the digestate outlet of the anaerobic bioreactor, an effluent outlet, and a second sludge outlet, a mixing tank fluidly having an inlet fluidly connected to the effluent outlet of the aerobic membrane bioreactor source, and an outlet, a source of separation additive configured to introduce the separation additive into the mixing tank, a cross-flow membrane filtration unit having an inlet fluidly connected to the outlet of the mixing tank, a first filtrate outlet, and a first retentate outlet, a solids-liquid separator having an inlet fluidly connected to first sludge outlet of the anaerobic bioreactor, the second sludge outlet of the aerobic membrane bioreactor, and the first reject outlet of the cross-flow membrane filtration unit, the solids-liquid separator further having a recovered water outlet fluidly connected to the inlet of the mixing tank, a nanofiltration unit having an inlet fluidly connected to the first filtrate outlet of the cross-flow membrane filtration unit, a second filtrate outlet, and a second reject outlet, a first reverse osmosis unit having an inlet fluidly connected to the second filtrate outlet of the nanofiltration unit, a third filtrate outlet, and a third reject outlet, and a second reverse osmosis unit having an inlet fluidly connected to the third reject outlet of the first nanofiltration unit, a fourth filtrate outlet, and a fourth reject outlet.

In some embodiments, the solids-liquid separator comprises a centrifuge.

In some embodiments, the system further comprises a source of antiscalant configured to introduce antiscalant into the inlet of the nanofiltration unit.

In some embodiments, the system further comprises a source of antiscalant configured to introduce antiscalant into the inlet of the first reverse osmosis unit.

In some embodiments, the system further comprises a source of antiscalant configured to introduce antiscalant into the inlet of the second reverse osmosis unit.

In some embodiments, the system further comprises a bypass line configured to fluidly connect the source of the organic material-containing wastewater to the inlet of the aerobic membrane bioreactor while bypassing the anaerobic bioreactor.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a box diagram of a system for treatment of organic compound-containing wastewater, according to one embodiment;

FIG. 2 is a box diagram of a portion of a system for treatment of organic compound-containing wastewater, according to one embodiment; and

FIG. 3 is a box diagram of a portion of a system for treatment of organic compound-containing wastewater, according to one embodiment.

### DETAILED DESCRIPTION

Developing and promoting renewable energy sources is of increasing interest globally, particularly with the effort to reduce greenhouse gas emissions and achieve a carbon neutral footprint. One such renewable energy source is renewable fuels, for example, ethanol produced from, e.g., wood, corn sugars, cane sugars, beet sugars, and/or cellulosic sugars. While these renewable fuels show great promise, their production typically produces large volumes of wastewater, and this wastewater must be factored into the overall consideration of carbon footprint.

In one aspect, this disclosure relates to a system and method which can be employed to treat wastewater streams from a renewable fuel production facility (e.g., renewable fuels produced from corn sugars, cane sugars, beet sugars, and potentially also cellulosic sugars) for beneficial recycle and reuse such that the overall system maximizes sustainability through water conservation and a carbon neutral footprint. The wastewater streams may contain phenolic compounds and high concentrations of organic compounds besides high concentration of total dissolved solids (TDS). All of these wastewater constituents present a unique challenge for water treatment and conservation. Aspects and embodiments of the system and method disclosed herein may generally relate to anaerobic digestion of the organic components of the wastewater, and reducing or minimizing fresh water consumption. In particular, the amount of fresh water used by the disclosed system and method may be reduced or minimized by recovering purified water from the process. The disclosure relates to systems and methods for recovering the purified water.

Wastewater treated by the systems and methods disclosed herein may be free of animal waste and may be pre-treated to remove oil and suspended solids prior to treatment by the systems and methods disclosed herein. The pretreated wastewater may have very low, and in some instances, undetectable, levels of suspended solids or ammonia, but relatively high amounts of phenolic compounds, chemical oxygen demand (COD), biological oxygen demand (BOD), and TDS.

In one aspect of the present disclosure, anaerobic digestion of a wastewater stream is used to recover biogas. In anaerobic digestion, a mixed culture of bacteria mediates the degradation of the putrescible fraction of organic matter ultimately to methane, carbon dioxide, and mineralized nutrients. Upon storage, the feed stock begins this process of degradation, resulting in the production of intermediate compounds, which are volatile and often a source of odors. Since methanogenic microorganisms grow slowly and are present in limited numbers in fresh biomass, these volatile intermediates accumulate in stored biomass. In an effective anaerobic digester, the growth of methanogens is promoted such that the intermediate compounds are converted to biogas and nutrients, and the odor potential of the biomass is greatly reduced. In some instances, the recovered biogas may be converted to heat energy which can be used as heat for various processes in the facility, or the biogas can be converted to electrical energy with an internal combustion engine.

In additional to biogas recovery, another important factor is the minimization of water consumption and output of high-quality treated water.

The principal means for promoting methanogenic growth in anaerobic digestion of biomass are controlling the operating temperature and/or controlling the residence time of the bacteria within the process. The types of anaerobic digester that have been implemented in the digestion of biomass are rather limited due to the nature of biomass as a substrate. The digester types have included variations of batch and semi-continuous processes, which include plug-flow digesters, complete-mix digesters, covered lagoons, and continuously stirred reactors.

During anaerobic treatment, wastewater including organic material may be directed to a tank or reactor comprising anaerobic microorganisms. The anaerobic microorganisms convert biologically degradable material in the wastewater primarily into water, biogas, and biosolids. In particular, anaerobic microorganisms facilitate decomposition of macromolecular organic matter into simpler compounds and biogas by methane fermentation. Exemplary anaerobic microorganisms include methanogens and acetogens. The produced biogas is primarily carbon dioxide and methane but may include other constituents depending on the composition of the wastewater.

Anaerobic treatment may generally refer to situations in which the prevailing conditions of the mixed liquor within the tank or reactor are anaerobic. The tank or reactor may be closed. The tank or reactor may be open. In particular, even in embodiments in which the anaerobic treatment tank or reactor is open, anaerobic treatment may occur in the absence of added oxygen when the prevailing conditions in the water are anaerobic.

Microorganism growth may be promoted by addition of microorganisms during start-up and/or dosing with microorganism nutrients. The odor potential of the organic material may be greatly reduced. Methanogenic growth in anaerobic digestion of organic material may be controlled by controlling operating temperature, residence time of the bacteria within the digestor, and/or mixing conditions.

Anaerobic digestion of wastewater containing biomass may be a batch or semi-continuous processes. For instance, anaerobic digestion may be performed in plug-flow digesters, complete-mix digesters, covered lagoons, or continuously stirred reactors.

In additional to biogas recovery, one important factor is the minimization of water consumption. The process of treating biomass consumes vast quantities of water. However, it is possible to treat the wastewater and recover a large percentage of the water so that the amount of fresh water required is minimized. The systems and methods disclosed herein may be utilized to treat the process wastewater and recover a percentage of the water to reduce or minimize the amount of fresh water required.

Thus, in accordance with one aspect, there are provided systems and methods for treating wastewater streams from a renewable fuel production facility.

The method may comprise introducing the wastewater into a holding tank and adjusting the pH of the wastewater in the holding tank by addition of an acid or base as needed to bring the pH of the wastewater to a pH conducive for anaerobic digestion, for example, a pH of between 6 and 8.

From the storage tank the pH adjusted wastewater (or non-pH adjusted wastewater if pH adjustment was not deemed necessary) is introduced through a feed pump and a coarse screen (for example, a ¼ inch mesh strainer) into an anaerobic bioreactor. In some embodiments, the anaerobic bioreactor may be an ADI-BVF® reactor from Evoqua Water Technologies, LLP. The organic material in the wastewater is digested in the anaerobic bioreactor, producing biogas, sludge, and an anaerobically treated effluent or digestate having a lower oxygen demand than the wastewater introduced into the anaerobic bioreactor. The anaerobically treated effluent or digestate may also have a reduced nitrogen content as compared to the wastewater introduced into the anaerobic bioreactor. As disclosed above, the biogas may be, e.g., converted to heat energy and/or converted to electrical energy with an internal combustion engine. The sludge outlet of the anaerobic bioreactor may be fluidly connected to a centrifuge, where solids are separated from liquid in the sludge for disposal and/or reuse. In some embodiments, the separated solids may be utilized for, e.g., land application. Biogas samples may be collected and used to measure the biogas composition (CH₄, CO₂, H₂S, and O₂). In some embodiments, a portion of the influent wastewater may be directed through a bypass line and not be treated in the anaerobic bioreactor.

The digestate/anaerobically treated effluent is combined with any wastewater that bypassed the anaerobic bioreactor and is introduced into an aerobic membrane bioreactor. An oxygen-containing gas, for example, air is supplied to an aeration diffuser in the aerobic membrane bioreactor using an air pump. Sludge generated in the aerobic membrane bioreactor may also be directed to the centrifuge, optionally after combination with the sludge generated in the anaerobic bioreactor, where solids are separated from liquid in the sludge for disposal and/or reuse.

Alternatively, in some embodiments, the aerobic MBR step may be replaced with other biological processes, including but not limited to a conventional activated sludge process (CAS) or sequential batch reactor (SBR) process for organic polishing.

Aerobically treated, low-solids effluent from the aerobic membrane bioreactor is directed into a mixing tank for softening, for example, by the addition of lime and/or caustic. A coagulant, for example, ferric chloride and/or a flocculant, for example, a polymer may also be mixed into the aerobic membrane bioreactor effluent in the mixing tank. In some embodiments, liquid separated from sludge in the centrifuge is mixed with the low-solids effluent from the aerobic membrane bioreactor in the mixing tank or prior to the mixing tank. After softening and coagulation, the partially treated wastewater is fed into a cross-flow membrane filtration unit for calcium, magnesium, and phosphorus removal. Concentrate from the cross-flow membrane filtration unit, also referred to herein as a first reject stream, may be sent to the centrifuge and mixed with the sludges from the anaerobic bioreactor and aerobic membrane bioreactor for water recovery.

The filtrate from the cross-flow membrane filtration unit, referred to as a first filtrate herein, is directed through a water recovery sub-system. Water recovery in the water recovery sub-system may involve passing the first filtrate from the cross-flow membrane filtration unit through at least one nanofiltration (NF) unit for recalcitrant organic compounds polishing and at least one first reverse osmosis (RO) unit for total dissolved solids (TDS) removal such that high-quality treated water capable of meeting reuse requirements is produced. The at least one nanofiltration unit separates the first filtrate into a second filtrate and a second reject stream. In some embodiments, an antiscalant and/or an acid (for example, sulfuric acid) or base for pH adjustment may be added to the first filtrate from the cross-flow membrane filtration unit prior to entering the NF unit(s) and/or to the second filtrate from the NF unit(s) prior to entering the first RO unit(s).

In some embodiments, reject from the at least one first RO membrane process, referred to as a third reject stream herein, may be directed to a brine recovery RO system (a second RO unit) for further waste stream recovery. In some embodiments, an antiscalant may be introduced into the third reject stream prior to processing through the brine recovery RO system as well.

The filtrate from the first RO unit, referred to as a third filtrate herein, and the filtrate from the brine recovery RO system, referred to as a fourth filtrate herein, may be combined as a product water stream. The second reject stream from the NF unit(s) and a reject stream from the second RO, referred to as a fourth reject stream herein unit may be combined and disposed of.

In some embodiments, the NF/RO skid is a microprocessor-controlled unit, which can be fitted with three 40″ long 2.4″ diameter NF or RO modules. The skid includes a VFD-controlled positive displacement type high pressure pump, four flow indicators, one temperature indicator, and three pressure gauges. Different membranes will be used for the nanofiltration and RO steps.

The systems and methods disclosed herein may include anaerobically digesting the organic compound-containing wastewater to produce a biogas and a digestate. Anaerobic digestion includes bringing the organic material into contact with a microorganism population in a substantially anaerobic environment. The anaerobic microorganism population may break down organic matter from the wastewater and produce biogas. During anaerobic digestion, organic nitrogen may be converted to ammonia. Temperature of the anaerobic digestion may be controlled. In some embodiments, temperature of the anaerobic digestion may be between, for example, 90-100° F. (32-38° C.) or 95-100° F. (35-38° C.). The anaerobic microorganism mixed liquor within the digester may be agitated, for example, in a continuous stirred tank reactor.

Nutrients and/or alkalinity agents may be supplied to the anaerobic microorganisms, for example, nitrogen, phosphorous, sodium bicarbonate, urea, phosphoric acid, and combinations thereof. Total Kjeldahl Nitrogen (TKN) and ammonia nitrogen (NH₃—N) measurements of the digestate may be used to determine whether sufficient nitrogen is available for the digestion process. Phosphate phosphorous (PO₄—P) measurements of the digestate may be used to determine whether sufficient phosphorous is available for the digestion process. Thus, the methods may comprise measuring nitrogen content and/or phosphorous content of the digestate. The methods may comprise supplying an effective amount of nutrients and/or alkalinity agents responsive to the digestate measurement.

Residence time of the mixed liquor within the anaerobic digester may be controlled. The wastewater may be in contact with the microorganism population for an amount of time sufficient to convert a predetermined amount of biomass into biogas. In some embodiments, the wastewater may be in contact with the microorganism population for an amount of time sufficient to exhaust biogas production from the wastewater. The hydraulic retention time (HRT) of the mixed liquor in anaerobic digestion may be 15-35 days, for example, 20-30 days, about 15 days, about 20 days, about 25 days, about 30 days, or about 35 days.

The method may comprise collecting the raw biogas produced by the digestion of organic material in the anaerobic bioreactor. The raw biogas may comprise methane and carbon dioxide. The raw biogas may comprise water vapor. The raw biogas may comprise additional constituents or nutrients based on the composition of the wastewater. In some embodiments, the raw biogas may be at least 40% methane, at least 45% methane, at least 50% methane, at least 55% methane, at least 60% methane, or at least 65% methane. Carbon dioxide may make up a majority of the remainder of the biogas.

The method may comprise measuring the flow volume of the raw biogas. The method may comprise measuring the composition of the raw biogas produced by the digestion. The composition of the raw biogas may depend on the composition of the wastewater. For example, the composition of the raw biogas may depend on carbon to nitrogen ratio (C:N). pH, moisture, total solids, temperature, biological oxygen demand (BOD), loading rate, and HRT of the wastewater.

The methods may comprise measuring methane content of the raw biogas. The methods may comprise controlling one or more parameter of the digestion responsive to the methane measurement, for example, controlling temperature, mixing conditions, loading rate, or HRT of the digestion responsive to the methane concentration being below a predetermined threshold, for example, below 55%, below 50%, below 45%, or below 40%.

Certain parameters may be controlled to increase methane content of the raw biogas. In exemplary embodiments, pH of the wastewater may be controlled to be about 6-8.Temperature may be controlled to be 90-100° F. (32-38° C.), for example, 95-100° F. (35-38° C.). Mixing conditions of the mixed liquor within the digester may be controlled.

The systems and methods disclosed herein may use energy generated by the biogas. In some embodiments, energy may be generated by the biogas in the form of heat energy. Heat energy may be captured from the biogas with a boiler or combined heat and power process. The captured heat energy may be used by one or more unit operations of the system. The captured heat energy may be used by a unit operation of the facility. Heat energy may be converted with a heat exchanger loop. For example, heat energy may be transferred to an energy demand with a heat exchanger loop. The energy demand may include one or more unit operations of the system and/or another unit operation of the facility.

In some embodiments, energy may be generated by the biogas in the form of electrical energy. Energy from the biogas may be converted to electrical energy with an internal combustion engine and generator. The electrical energy may be used to operate one or more unit operations of the system and/or another unit operation of the facility.

In some embodiments, the method may comprise processing the raw biogas to produce natural gas. The raw biogas may be refined and converted to natural gas, for example, renewed natural gas (RNG). The refinement process may include removing moisture, carbon dioxide, and trace level contaminants from the raw biogas including, for example, any siloxanes, volatile organic compounds (VOCs), and hydrogen sulfide. The refinement process may include removing nitrogen and oxygen content of the raw biogas. The refinement process may produce a natural gas having a methane content of at least 90%. In some embodiments, the produced natural gas may have a methane content of at least 92%, at least 94%, at least 96%, or at least 98%. The produced natural gas may be injected into a conventional natural gas pipeline or used to replace fossil fuel natural gas in any existing application. For example, the produced natural gas may be used to generate electrical energy. The electrical energy may be used by one or more unit operations of the system and/or a unit operation of the facility.

The digestate produced by the anaerobic digestion may be a sludge-containing wastewater. The method may comprise separating the digestate to produce a digestate solids and recovered water. The digestate solids may retain substantially all of the suspended solids from the digestate and a portion of the dissolved solids. Thus, the separation may reduce TSS of the stream by at least 95%, at least 98%, at least 99%, at least 99.9%, or at least 99.99%, The separation may reduce TDS of the stream by about 30%-65%, for example, about 35%, about 50%, or about 65%. The separation may be performed by one or more of centrifuge separation, thickening, straining, settling, and membrane filtration. The digestate solids may be collected to produce a solids product. The recovered water may be further treated to produce product water.

The separation of the digestate into digestate solids and recovered water may comprise dosing the digestate, before or after treatment in the aerobic membrane bioreactor, with at least one of a coagulant and a flocculant to produce a digestate sludge. A coagulant may induce coagulation of suspended solids in the digestate. Coagulation may be induced by destabilization of colloidal and dispersed particles, inducing growth to larger particle sizes. Exemplary coagulants include anionic and cationic molecules. A flocculant may induce flocculation of suspended solids in the digestate. Flocculation may be induced by agglomerating solids, such as coagulated solids and other suspended solids, into aggregates or complexes. Exemplary flocculants include high molecular weight polymers having exposed bonding groups to aggregate suspended and coagulated solids. Certain separation additives may act as both coagulants and flocculants. Exemplary separation additives include calcium hydroxide (lime), ferric sulfate, anionic polymers, and cationic polymers. One exemplary separation additive is Alumafloc™ (distributed by Siemens Industry, Inc., Munich, Germany). Thus, the separation may comprise dosing the digestate with one or more of calcium hydroxide, ferric sulfate, an anionic polymer, and a cationic polymer. The digestate sludge comprising the agglomerated solids may be collected to produce the solids product.

In exemplary embodiments, the digestate may be dosed with calcium hydroxide. Calcium hydroxide may induce agglomeration of suspended solids as a coagulant. Calcium hydroxide may also reduce calcium and magnesium concentration of the solution, as a softener. For instance, the methods may comprise dosing the digestate with an amount of calcium hydroxide effective to produce a filtrate with at least 95%, at least 98%, at least 99%, at least 99.9%, or at least 99.99% less calcium and magnesium than the digestate. Additionally, calcium hydroxide may increase the pH of the solution.

The methods may comprise dosing the one or more of the filtrates from the cross-flow membrane filtration unit, NF unit(s), and/or first RO unit(s) with an antiscalant. The antiscalant may be a silica, sulfate (for example, barium sulfate, calcium sulfate, strontium sulfate), calcium carbonate, and/or calcium fluoride scale inhibitor. Thus, one or more of the filtrates may be dosed with an effective amount of the antiscalant to inhibit formation of scale on one or more downstream unit operations, for example, a microfiltration unit, a nanofiltration unit, and/or a reverse osmosis unit. In exemplary embodiments, the antiscalant may comprise Vitec® 7400 (distributed by Avista Technologies, Inc., San Marcos, CA).

The methods may comprise dosing one or more of the filtrates with potassium bisulfite. Potassium bisulfite may be used to neutralize chlorine, chloramines, and residual ammonia in the filtrates.

The systems and methods disclosed herein may involve removing organic contaminants and divalent anions from the first filtrate from the cross-flow membrane filtration unit to produce an organic-containing reject and an organic-depleted filtrate. The organic contaminants and divalent anions may be removed by nanofiltration to produce an organic-depleted filtrate, also referred to as a second filtrate herein.

The organic-depleted second filtrate may have 40-60% less TDS than the first filtrate from the cross-flow membrane filtration unit, for example, 40-50% less TDS. The organic-depleted second filtrate may have at least 90% less calcium and magnesium than the first filtrate from the cross-flow membrane filtration unit, for example, at least 90%, at least 95%, at least 98%, at least 99%, at least 99.9%, or at least 99.99% less calcium and magnesium. The organic-depleted second filtrate may have 10 ppm calcium or less, for example, 5 ppm calcium or less, or 1 ppm calcium or less. The organic-depleted second filtrate may have 10 ppm magnesium or less, for example, 5 ppm magnesium or less, or 1 ppm magnesium or less.

The methods may comprise controlling pH of the organic-depleted second filtrate to less than about 8, for example, between about 4-8 or 6-8. The pH of the organic-depleted second filtrate may be controlled by dosing the organic-depleted second filtrate with an effective amount of a pH adjuster.

The method may comprise dosing the organic-depleted second filtrate with an antiscalant. The organic-depleted second filtrate may be dosed with an effective amount of the antiscalant to inhibit formation of scale on one or more downstream unit operations, for example, a microfiltration unit, a nanofiltration unit, and/or a reverse osmosis unit.

The systems and methods disclosed herein may involve concentrating the organic-depleted second filtrate to produce a third reject stream and a third filtrate. The organic-depleted second filtrate may be concentrated by reverse osmosis. The organic-depleted second filtrate may be concentrated by brine recovery reverse osmosis. The methods may comprise concentrating the organic-depleted second filtrate between 2×-5×, for example, about 2×, about 3×, about 4×, or about 5×, to produce the third reject stream.

The third filtrate may have at least 90% less TDS than the organic-depleted second filtrate, for example, at least 90%, at least 95%, at least 98%, at least 99%, at least 99.9%, or at least 99.99% less TDS.

The method may comprise concentrating the third reject stream of the first RO unit(s) to produce a fourth reject stream and a fourth filtrate. The third reject stream of the first RO unit(s) may be concentrated by reverse osmosis. The third reject stream of the first RO unit(s) may be concentrated by brine recovery reverse osmosis. The methods may comprise concentrating the third reject stream of the first RO unit(s) between 2×-5×, for example, about 2×, about 3×, about 4×, or about 5×, to produce the fourth reject.

The fourth filtrate may have at least 90% less TDS than the third reject stream of the first RO unit(s), for example, at least 90%, at least 95%, at least 98%, at least 99%, at least 99.9%, or at least 99.99% less TDS.

The method may comprise combining the fourth filtrate from the second RO unit with the third filtrate from the first RO unit(s). These two filtrates may be combined in amounts effective to have 200-500 ppm TDS in the resultant product water. For example, the combined filtrates may have 1:5-5:1 third filtrate to fourth filtrate, for example, 2:1-5:1, 3:1-4:1, or 3:1-5:1 third filtrate to fourth filtrate.

The systems and methods disclosed herein may produce a solids product from organic material-containing wastewater. In some embodiments, the solids product may be treated. For example, the solids product may be dried. Residual moisture may be captured from the drier and returned to the digestion or water recovery processes. The solids product may be used to produce a class A biosolids product. Solids products produced by the disclosed methods may comply with requirements for class A biosolids as established by the United States Environmental Protection Agency (EPA). The solids product may be used as a fertilizer product. The solids product may be supplemented with nutrients and/or fertilizer agents. The solids product may be used as an organic product, for example, a certified product suitable for organic farming. Fertilizer products produced by the disclosed methods may comply with requirements outlined by the Organic Materials Review Institute (OMRI).

In certain embodiments, the dosing agents disclosed herein, for example, coagulant, flocculant, softener, pH adjuster, antiscalant, and cleaning agent, may be acceptable to produce a class A biosolids product. Solids products containing dosing agents produced by the disclosed methods may comply with requirements for class A biosolids as established by the EPA. The dosing agents may be acceptable to produce an organic product, for example, a certified product suitable for organic farming. Fertilizer products containing dosing agents produced by the disclosed methods may comply with requirements outlined by the OMRI.

The wastewater treatment process disclosed herein enables the recycle and reuse of waste inventory with reduced carbon footprint, which includes generation of renewable natural gas (RNG) from the anaerobic digestion, production of high-quality water, and solids from the dewatering process for potential land application.

In accordance with another aspect, there is provided a system for treating wastewater comprising organic materials. The system may include an organic material digestion subsystem and a water recovery subsystem. The organic material digestion subsystem may be configured to effectively digest the organic material and produce biogas, digestate solids, and digestate liquids. The water recovery subsystem may be configured to treat the digestate liquids and recover a substantial amount of water from the digestate liquids.

The organic material digestion subsystem may comprise an anaerobic digester having an inlet fluidly connected to a source of organic material-containing wastewater, a biogas outlet, and a digestate outlet. The anaerobic digester may be an enclosed vessel or semi-enclosed vessel housing activated sludge comprising anaerobic microorganisms. The anaerobic digester may comprise a temperature control unit including, for example, a temperature sensor and a heater and/or chiller. The temperature control unit may be configured to control temperature of the mixed liquor within the anaerobic digester. The anaerobic digester may comprise an element for agitating the mixed liquor within the digester. In some embodiments, the anaerobic digester may be a continuous stirred tank reactor (CSTR).

The system may comprise a biogas processing unit fluidly connected to the biogas outlet. The biogas processing unit may include an energy harvesting unit. The energy harvesting unit may include a boiler or combined heat and power process. A heat exchanger and/or heat pump may be used to transfer thermal energy from the energy harvesting unit to an energy demand. In some embodiments, the heat exchanger and/or heat pump can be located onsite. Distance may be minimized between the biogas outlet of the anaerobic digester and the boiler or combined heat and power process to capture as much heat energy as possible. The energy demand may be an onsite energy demand, such as a unit operation of the system, a unit operation of the facility, and/or an ambient heating system of the facility.

The energy harvesting unit may include a combustion engine and generator configured to generate electrical energy. The combustion engine may be located onsite. The combustion engine may be configured to use the biogas or natural gas produced from the biogas as fuel. The combustion engine may be electrically connected to an energy demand, for example, an onsite energy demand. The energy demand may be an off-site energy demand. For example, electrical energy may be generated onsite to serve an off-site energy demand. In some embodiments, the combustion engine may be located off-site.

The biogas processing unit may include a biogas treatment unit. The biogas treatment unit may be configured to refine and convert the biogas to natural gas, as previously described. In some embodiments, the biogas treatment unit may be onsite. In other embodiments, the biogas treatment unit may be remotely located.

The organic compound digestion subsystem may comprise a first solids-liquid separation subsystem having an inlet fluidly connected to the digestate outlet, at least one digestate solids outlet, and a recovered water outlet. The first solids-liquid separation subsystem may be configured to produce the digestate solids and the recovered water. The first solids-liquid separation subsystem may comprise one or more of a centrifuge, a clarifier, and a membrane filter.

The first solids-liquid separation subsystem may comprise a centrifuge having an inlet fluidly connected to the sludge outlets of the anaerobic bioreactor and aerobic membrane bioreactor as well as the first reject outlet of the cross-flow membrane filtration unit, a digestate solids outlet, and a recovered water outlet. The centrifuge may be configured to separate suspended solids to the digestate solids outlet and the remaining liquid stream to the recovered water outlet. The organic compound digestion subsystem may comprise a source of a separation additive. For example, the organic compound digestion subsystem may comprise at least one of a source of a coagulant and a source of a flocculant positioned upstream from the cross-flow membrane filtration unit and/or centrifuge.

In one exemplary embodiment, the first solids-liquid separation subsystem may comprise a source of calcium hydroxide positioned upstream from the cross-flow membrane filtration unit and/or centrifuge. The first solids-liquid separation subsystem may comprise a source of an anionic polymer also positioned upstream from the cross-flow membrane filtration unit and/or centrifuge. The first solids-liquid separation subsystem may comprise a source of ferric sulfate positioned upstream from the cross-flow membrane filtration unit. The first solids-liquid separation subsystem may comprise a source of a cationic polymer positioned upstream from the cross-flow membrane filtration unit.

The system may comprise a solids product holding tank fluidly connected to the digestate solids outlet of the first solids-liquid separation subsystem. The system may comprise a dosing agent holding tank. The dosing agent holding tank may be configured to capture dosing agents, for example, coagulant, flocculant, pH adjusters, or others for reuse. The dosing agent holding tank may be fluidly connected to an upstream reactor.

The water recovery subsystem may comprise a plurality of membrane filtration units. A first of the membrane filtration units may be a nanofiltration unit. The nanofiltration unit includes an inlet, a reject outlet, and a filtrate outlet. The water recovery subsystem may include multiple nanofiltration units fluidly coupled in series and/or parallel. A source of antiscalant or bisulfite may be disposed upstream of the nanofiltration unit to dose the first filtrate from the cross-flow membrane filtration unit with antiscalant prior to entering the nanofiltration unit. The nanofiltration unit may be a membrane filter, a hollow fiber membrane filter, a plate and frame membrane filter, a spiral membrane, a dead end filter, a cross-flow filter, or any other type of filter having pores dimensioned to perform nanofiltration. The average pore size of the nanofiltration membrane may be 1 to 100 nm, for example 1 to 10 nm. The nanofiltration unit may separate the first filtrate from the cross-flow membrane filtration unit into a second filtrate that is provided to the filtrate outlet of the nanofiltration unit and a second reject that is provided to the reject outlet.

A first reverse osmosis unit may be fluidly disposed downstream of the nanofiltration unit and may have an inlet fluidly coupled to the filtrate outlet of the nanofiltration unit, a filtrate outlet, and a reject outlet. A second source of antiscalant may be disposed upstream of the reverse osmosis unit to dose the second filtrate from the nanofiltration unit with antiscalant prior to entering the reverse osmosis unit. The first reverse osmosis unit separates the second filtrate from the nanofiltration unit into product water (a third filtrate) that is provided to the filtrate outlet and a third reject stream that is provided to the reject outlet. In some embodiments, more than one reverse osmosis unit may be fluidly connected in series or parallel to further treat the second filtrate from the nanofiltration unit.

A second reverse osmosis unit may be disposed fluidly downstream of the first reverse osmosis unit and may include an inlet in fluid communication with the reject outlet of the first nanofiltration unit for receiving the third reject stream from the first reverse osmosis unit, a filtrate outlet, and a reject outlet. The second reverse osmosis unit may be a brine recovery reverse osmosis unit. A third source of antiscalant may be disposed upstream of the second reverse osmosis unit to dose the third reject from the first reverse osmosis unit with antiscalant prior to entering the second reverse osmosis unit. The second reverse osmosis unit separates the third reject stream from the first reverse osmosis unit into a fourth filtrate that is provided to the filtrate outlet of the second reverse osmosis unit and a fourth reject that is provided to the reject outlet. The filtrates from the first and second reverse osmosis units may be combined to produce the product water stream. The fourth reject from the second reverse osmosis unit may be combined with the second reject from the nanofiltration unit and disposed of.

The system may comprise a solids product treatment subsystem. The solids product treatment subsystem may be positioned onsite, downstream from the solids product holding tank. The solids product treatment subsystem may be positioned at a remote location. The solids product treatment subsystem may be configured to process the solids product to produce a class A biosolids product. The solids product treatment subsystem may be configured to process the solids product to produce a fertilizer product. In some embodiments, the solids product treatment subsystem may comprise a drier. The solids product treatment subsystem may comprise a source of nutrients and/or fertilizer agent.

The system may comprise one or more pumps or valves configured to direct fluid through the unit operations. The system may comprise one or more sensors, for example, composition sensors, configured to measure composition of one or more fluid. The system may comprise one or more pH sensors configured to measure pH of one or more fluid. In some embodiments, the system may comprise a digestate composition sensor. The sensor may be configured to measure one or more of TKN, NH₃—N, and PO₄—P of the digestate. In some embodiments, the system may comprise a biogas composition sensor. The sensor may be configured to measure methane content of the biogas. In some embodiments, the system may comprise a biogas flow volume sensor. In some embodiments, the system may comprise a wastewater composition sensor. The sensor may be configured to measure one or more of pH, total solids, BOD, and C:N of the wastewater.

The system may comprise a controller operably connected to the one or more sensor and configured to alert a user responsive to the sensor measuring a value outside tolerance of a predetermined range. The controller may be operably connectable to the one or more pumps or valves. For example, the controller may be configured to direct administration of a dosing agent responsive to a measured value, for example, a measured pH unit. In some embodiments, the controller may be operably connectable to the temperature control unit of the anaerobic digester. The controller may be operably connectable to the stirrer of the anaerobic bioreactor.

In exemplary embodiments, the controller may be configured to dose the wastewater with nutrients and/or alkalinity agents responsive to the composition of the digestate, for example, TKN, NH₃—N, and/or PO₄—N concentration of the digestate. In some embodiments, the controller may be configured to modify mixing conditions of the anaerobic digester responsive to the methane content of the biogas or flow volume of the biogas.

The controller may be a computer or mobile device. The controller may comprise a touch pad or other operating interface. For example, the controller may be operated through a keyboard, touch screen, track pad, and/or mouse. The controller may be configured to run software on an operating system known to one of ordinary skill in the art. The controller may be electrically connected to a power source. The controller may be digitally connected to the one or more components. The controller may be connected to the one or more components through a wireless connection. For example, the controller may be connected through wireless local area networking (WLAN) or short-wavelength ultra-high frequency (UHF) radio waves. The controller may further be operably connected to any additional pump or valve within the system, for example, to enable the controller to direct fluids or additives as needed. The controller may be coupled to a memory storing device or cloud-based memory storage.

Multiple controllers may be programmed to work together to operate the system. For example, a controller may be programmed to work with an external computing device. In some embodiments, the controller and computing device may be integrated. In other embodiments, one or more of the processes disclosed herein may be manually or semi-automatically executed.

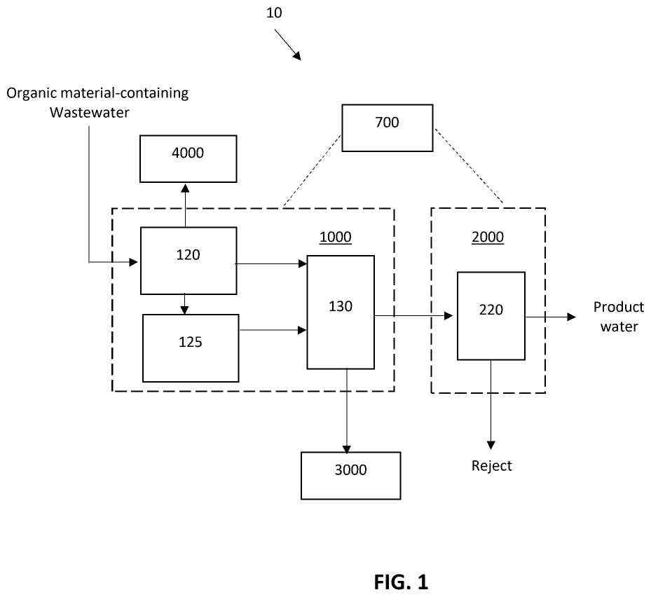

Referring to FIG. 1, a system 10 for treatment of organic compound-containing wastewater is shown. The system 10 comprises an organic material digestion subsystem 1000 and a water recovery subsystem 2000. The organic material digestion subsystem 1000 comprises an anaerobic bioreactor 120, and aerobic membrane bioreactor 125, and a solids-liquid separation subsystem 130. The anaerobic bioreactor 120 may be an ADI-BVF®; reactor from Evoqua Water Technologies, LLP. The water recovery subsystem 2000 may include a second solids-liquid separation subsystem 220. The organic material digestion subsystem 1000 has a solids outlet fluidly connected to a solids product subsystem 3000 comprising a holding tank. The solids product subsystem 3000 may comprise a solids product treating subsystem. Biogas produced by the anaerobic digester 120 is directed to a biogas processing subsystem 4000. The biogas processing subsystem 4000 may comprise an energy harvesting unit and/or a biogas treatment unit. The water recovery subsystem 2000 has a product water outlet configured to direct recovered water to a point of use. The water recovery subsystem 2000 has a reject outlet to direct reject to a reject disposal system, for example, a sewer. The system 10 may be operated to recover water from the digestion process and produce minimal liquid waste. A controller 700 is provided to control operations of the system 10.

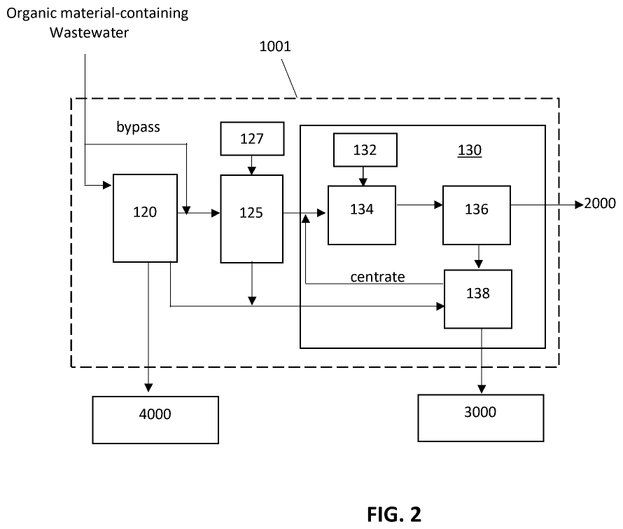

Referring to FIG. 2, an exemplary biomass digestion subsystem 1001 is shown. The biomass digestion subsystem 1001 includes anaerobic bioreactor 120, aerobic membrane bioreactor 125, and solids-liquid separation subsystem 130. A portion of the influent wastewater may bypass the anaerobic bioreactor 120 and may be introduced directly into the aerobic membrane bioreactor 125.

The aerobic membrane bioreactor 125 receives digestate from the anaerobic bioreactor 120 and is supplied with an oxygen-containing gas, for example, air from a source of the gas 127.

The solids-liquid separation subsystem 130 includes source of a separation additive 132, a reaction tank 134 for mixing the separation additive 132 with effluent from the aerobic membrane bioreactor 125, a cross-flow membrane filtration unit 136, and a solids-liquid separation apparatus 138, for example, a centrifuge. The separation additive may be a softening agent, coagulant, and/or a flocculant. The separation additive may comprise, for example, calcium hydroxide (lime), ferric sulfate, an anionic polymer, and/or a cationic polymer.

The anaerobic bioreactor 120 and aerobic membrane bioreactor 125 both produce sludge that is sent to the solids-liquid separation apparatus 138 for recovery of water and production of solids for disposal. A reject outlet of the cross-flow membrane filtration unit 136 is also fluidly connected to the solids-liquid separation apparatus 138. Liquid separated from the sludges from the anaerobic bioreactor 120 and aerobic membrane bioreactor 125 and from the reject from the cross-flow membrane filtration unit 136, for example, centrate, may be recycled to the reaction tank 134 or upstream of the reaction tank 134.

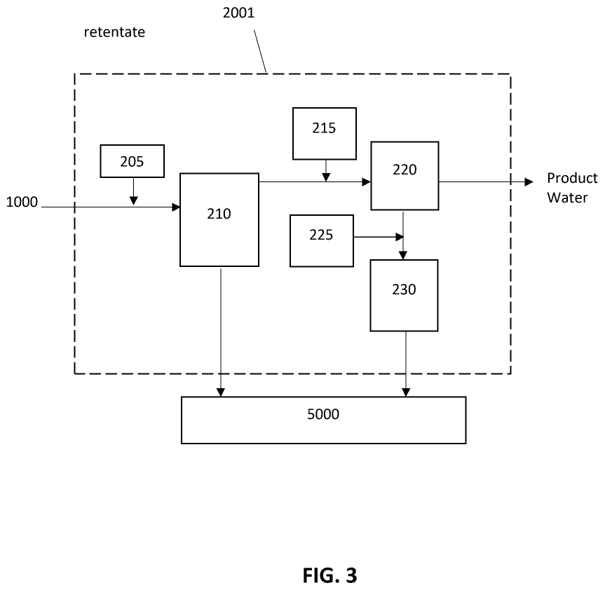

Referring to FIG. 3, an exemplary water recovery subsystem 2001 is shown. Water recovery subsystem 2001 includes a first filtration module 210, for example, a nanofiltration unit, a second filtration module 220, for example, a first reverse osmosis unit, and a third filtration module 230, for example, a second reverse osmosis unit. The second reverse osmosis unit 230 may be a brine recovery reverse osmosis unit. The nanofiltration unit 210 separates the first filtrate provided by the organic material digestion subsystem 1000 into a second filtrate and a second reject stream. The second filtrate stream is provided to an inlet of the first reverse osmosis unit 220. The second reject stream is sent to a reject disposal subsystem 5000. The first reverse osmosis unit separates the second filtrate into a third filtrate that may be output as product water and a third reject. The third reject is provided to an inlet of the second reverse osmosis unit 230. The second reverse osmosis unit 230 separates the third reject into a fourth filtrate which may be combined with the third filtrate as product water, and a fourth reject stream that may be combined with the second reject stream and directed into the reject disposal subsystem 5000.

Water recovery subsystem 2001 includes a first source of a dosing agent 204 configured to dose the first filtrate from the organic material digestion subsystem 1000 with, for example, an antiscalant or bisulfite prior to the first filtrate entering the nanofiltration unit 220. A second source of a dosing agent 215 is configured to dose the second filtrate from the nanofiltration unit 210 with an antiscalant prior to the second filtrate entering the first reverse osmosis unit 22. A third source of dosing agent is configured to dose the third reject from the first reverse osmosis unit 220 with an antiscalant prior to the third reject entering the second reverse osmosis unit 230.

### PROPHETIC EXAMPLE

Pretreated wastewater from a renewable fuel production facility is expected to exhibit the characteristics listed in Table 1 below. After treatment in the anaerobic digester and after treatment in the aerobic membrane bioreactor in a system as disclosed herein, the wastewater is expected to have the respective characteristics further listed in Table 1 below. The system disclosed herein is expected to remove nearly all COD, BOD, TDS, and phosphorous from the pretreated wastewater.

TABLE 1
Wastewater components

| | | Wastewater after | Wastewater after |
|---|---|---|---|
| | Pretreated | Anaerobic | Aerobic Membrane |
| Parameter | Wastewater | Bioreactor | Bioreactor |
| COD (mg/L) | 8216 | 1,000 | — |
| BOD (mg/L) | 5373 | 500 | <5 |
| TDS (mg/L) | 1714 | — | — |
| TKN (mg/L) | — | — | — |
| TP (mg/L) | 2 | — | — |
| pH | 6 | 6.5-7.5 | 7-8.5 |

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Having thus described several aspects of at least one embodiment, it is to be appreciated various alterations, modifications, and improvements will readily occur to those skilled in the art. Any feature described in any embodiment may be included in or substituted for any feature of any other embodiment. Such alterations, modifications, and improvements are intended to be part of this disclosure and are intended to be within the scope of the invention. Accordingly, the foregoing description and drawings are by way of example only.

Those skilled in the art should appreciate that the parameters and configurations described herein are exemplary and that actual parameters and/or configurations will depend on the specific application in which the disclosed methods and materials are used. Those skilled in the art should also recognize or be able to ascertain, using no more than routine experimentation, equivalents to the specific embodiments disclosed.

What is claimed is:

1. A method of treating wastewater from a renewable fuel production facility including high levels of phenolics, the method comprising:
anaerobically digesting the wastewater to produce a biogas, a digestate, and a waste sludge;
aerobically treating the digestate in an aerobic membrane bioreactor to produce an aerobically treated, low-solids effluent and a second waste sludge;
dosing the aerobically treated, low-solids effluent with a coagulant and softening agent in a mixing tank to produce a partially treated wastewater;
separating the partially treated wastewater in a cross flow membrane filtration unit into a first filtrate and a first reject;
treating the waste sludge, second waste sludge, and first reject in a solids-liquid separation apparatus to produce recovered water and waste solids;
directing the recovered water into the mixing tank;
dosing the first filtrate with an antiscalant to produce a dosed first filtrate;
filtering the dosed first filtrate in a nanofiltration unit to produce a second filtrate and a second reject stream;
dosing the second filtrate with an antiscalant to produce a dosed second filtrate;
filtering the dosed second filtrate in a first reverse osmosis unit to produce a third filtrate and a third reject stream;
dosing the third reject stream with an antiscalant to form a dosed third reject stream;
filtering the dosed third reject stream in a second reverse osmosis unit to produce a fourth filtrate and a fourth reject;
combining the third filtrate and fourth filtrate to form a product water; and
combining the second reject stream and the fourth reject stream into a combined reject stream for disposal.

2. The method of claim 1, wherein treating the waste sludge, second waste sludge, and first reject to produce the recovered water and waste solids is performed in a centrifuge.

3. The method of claim 1, further comprising processing the biogas to produce natural gas.

4. The method of claim 3, further comprising using energy generated by the biogas to power at least one operation of the method.

5. The method of claim 1, further comprising introducing a portion of the organic material-containing wastewater directly into the aerobic membrane bioreactor without first treating the portion of the organic material-containing wastewater in the anaerobic bioreactor.

6. The method of claim 1, further comprising adjusting a pH of the wastewater to about 6 or above prior to anaerobically digesting the wastewater.

7. The method of claim 1, further comprising pre-treating the wastewater to remove oil, suspended solids, and ammonia prior to anaerobically digesting the wastewater.

8. A system for treating wastewater from a renewable fuel production facility including high levels of phenolics, the system comprising:
an anaerobic bioreactor having an inlet fluidly connectable to a source of wastewater, a biogas outlet, a digestate outlet, and a sludge outlet;
an aerobic membrane bioreactor having an inlet fluidly connected to the digestate outlet of the anaerobic bioreactor, an effluent outlet, and a second sludge outlet;
a mixing tank fluidly having an inlet fluidly connected to the effluent outlet of the aerobic membrane bioreactor source, and an outlet
a source of separation additive configured to introduce the separation additive into the mixing tank;
a cross-flow membrane filtration unit having an inlet fluidly connected to the outlet of the mixing tank, a first filtrate outlet, and a first retentate outlet;
a solids-liquid separator having an inlet fluidly connected to first sludge outlet of the anaerobic bioreactor, the second sludge outlet of the aerobic membrane bioreactor, and the first reject outlet of the cross-flow membrane filtration unit, the solids-liquid separator further having a recovered water outlet fluidly connected to the inlet of the mixing tank;
a nanofiltration unit having an inlet fluidly connected to the first filtrate outlet of the cross-flow membrane filtration unit, a second filtrate outlet, and a second reject outlet;
a first reverse osmosis unit having an inlet fluidly connected to the second filtrate outlet of the nanofiltration unit, a third filtrate outlet, and a third reject outlet; and
a second reverse osmosis unit having an inlet fluidly connected to the third reject outlet of the first nanofiltration unit, a fourth filtrate outlet, and a fourth reject outlet.

9. The system of claim 8, wherein the solids-liquid separator comprises a centrifuge.

10. The system of claim 8, further comprising a source of antiscalant configured to introduce antiscalant into the inlet of the nanofiltration unit.

11. The system of claim 8, further comprising a source of antiscalant configured to introduce antiscalant into the inlet of the first reverse osmosis unit.

12. The system of claim 8, further comprising a source of antiscalant configured to introduce antiscalant into the inlet of the second reverse osmosis unit.

13. The system of claim 8, further comprising a bypass line configured to fluidly connect the source of the organic material-containing wastewater to the inlet of the aerobic membrane bioreactor while bypassing the anaerobic bioreactor.
